(19) United States
(12) Patent Application Publication
(10) Pub. No.: US 2002/0066475 A1
(43) Pub. Date: Jun. 6, 2002

(54) Chuck for holding wafer

(76) Inventors: Steven Verhaverbeke, San Francisco, CA (US); J. Kelly Truman, Morgan Hill, CA (US); Alexander Ko, Sunnyvale, CA (US); Rick R. Endo, San Carlos, CA (US)

Correspondence Address: Patent Counsel, APPLIED MATERIALS, INC., P.O. Box 450A, SANTA CLARA, CA, 95052, US

(21) Appl. No.: 09/891,989

(22) Filed: Jun. 25, 2001

Related U.S. Application Data
(60) Provisional application No. 60/214,115, filed on Jun. 26, 2000.

(51) Int. Cl. B08B 9/02

(52) U.S. Cl. 134/153; 134/902; 134/157

(57) ABSTRACT

A chuck for holding a wafer that includes a number of moveable clamping arms each pivotally attached to one or more fixed support structures; and a center-of-mass of each of the moveable clamping arms positioned a distance from the pivot point of each of the moveable clamping arms, such that when the chuck is at rest, the number of moveable clamping arms rotate to release a grip on the wafer, and when the chuck is rotating, the clamping arms rotate to grip the wafer.

This application is a non-provisional application of U.S. provisional application serial No. 60/214,115, filed Jun. 26, 2000.

### BACKGROUND OF THE INVENTION

1. Field of the Invention

The present invention relates to the field of apparatus for holding a substrate during the cleaning of one or more substrate surfaces, and more particularly to a chuck for holding a single semiconductor wafer during simultaneous sonic cleaning of both sides of the wafer.

2. Discussion of Related Art

In semiconductor wafer substrate (wafer) cleaning, particle removal is essential. Particles can be removed by chemical means or by mechanical means. In current state of the art, particles are usually removed by both a combination of mechanical means and chemical means. The current state of the art is to immerse a wafer into a bath filled with a liquid and to apply high frequency (megasonic) irradiation to the liquid. The sonic waves travel through the liquid and provide the mechanical means to remove particles from the wafer surface. At the same time, chemicals in the liquid provide a slight surface etching and provide the right surface termination, such that once particles are dislodged from the surface by the combination of etch and mechanical action of the sonics on the particles, these particles are not redeposited on the surface. In addition, chemicals are chosen such

that an electrostatic repulsion exists between the surface termination of the wafer and the particles.

Wet etching and wet cleaning of wafers is usually done by immersing the wafers into a liquid. This can also be done by spraying a liquid onto a wafer or a batch of wafers. Wet wafer cleaning and etching is traditionally done in a batch mode. Because of the need for a shorter cycle time in chip manufacturing, there is a need for fast single wafer processing. Single wafer processing is usually limited to one side of the wafer. When cleaning wafers, it is important to clean both sides of the wafers at the same time. When holding wafers, most current chucks hold the wafer with three or more supports, or use a vacuum support.

Chucks for single wafer cleaning have so far been of the type that holds the wafer on a plate, either held by vacuum or held by a N₂ cushion. These chucks do not allow double sided cleaning. Other chucks have held the wafers simply with three or more arms. The problem with these chucks is that the arms obstruct chemical spray and do not allow a brush to get to the backside of the wafer. When cleaning, it is important to have the wafer non-device side as free as possible of obstructions in order to have the wafer sides freely accessible for chemical or de-ionized water sprays and to have the wafer non-device side accessible for brushing. In addition, the arms have to move in order to clamp the wafer and the moving mechanism is exposed to chemical spray as well. There is a need for a chuck that leaves the wafer non-device side unobstructed in order for a brush to access the backside surface. Additionally, there is a need for a chuck that has a clamping mechanism that is easy to activate, does not cover areas of the wafer to be cleaned, and is resistant to any chemical sprays.

### SUMMARY OF THE INVENTION

A rotatable chuck for holding a single semiconductor wafer. The chuck has a number of moveable clamping arms that each rotate about a local pivot point. The moveable clamping arms each have a center-of-mass that is offset from its local pivot point. Upon rotation of the chuck, the result of centrifugal forces acting on the offset is to rotate each moveable clamping arm into a position. Upon stopping the chuck, the result of gravity acting on the offset is to rotate each of the movable clamping arms into a different position. One of the positions is to release the wafer and another position is to grip the wafer.

### BRIEF DESCRIPTION OF THE DRAWINGS

FIG. 1A is an illustration of a single wafer cleaning chamber.

FIG. 1B is an illustration of an alternate embodiment for using a wafer holding chuck.

FIG. 2A is an illustration of a 3D view of one embodiment of the chuck having moveable clamping arms.

FIG. 2B is an illustration of one embodiment of the moveable clamping arm.

FIG. 3A is cross-section of an alternate embodiment of a wafer holding chuck.

FIG. 3B is a top view of the alternate embodiment of the wafer holding chuck.

FIG. 4A is an illustration of a cross-section of another alternate embodiment of the wafer holding chuck.

FIG. 4B is an illustration of an end view of the embodiment.

FIG. 4C is an illustration of a top view of the embodiment.

FIG. 5 is an illustration of another alternate embodiment of the wafer holding chuck.

FIG. 6 is an illustration of a removal/insertion operation of the wafer.

### DETAILED DESCRIPTION OF THE PRESENT INVENTION

A chuck is disclosed for holding a wafer at an outer diameter edge to allow access to a wafer top surface and a wafer bottom surface for cleaning. The chuck can mechanically hold the wafer in place during cleaning operations that can include chemical flow, mechanical brushing, megasonic application, and wafer rotation. The chuck can use a variety of embodiments to operate as a latch and mechanically lock the wafer to the chuck in a position. The mechanical locking mechanism can be through one or a combination of; the use of rotational forces during wafer spin, the use of springs, or through the use of magnetics.

The use of acoustic wave transducers (transducers) generating in the megasonic range has recently become common in wafer cleaning. The difference between ultrasonic cleaning and megasonics cleaning lies in the frequency that is used to generate the acoustic waves. Ultrasonic cleaning uses frequencies from between 20-400 kHz and produces random cavitation. Megasonics cleaning uses higher frequencies beginning at between 350-400 kHz and may use frequencies well into the MHz range. Megasonics cleaning produces controlled cavitation. Cavitation, the formation and activity of bubbles, is believed to be an important mechanism in the actual particle removal process, because cavitation has sufficient energy to overcome particle adhesion forces and cause particles to be removed. Another mechanism is acoustic streaming which pushes the particles away so they do not reattach to the wafer. An important distinction between the two methods is that the higher megasonic frequencies do not cause the violent cavitation effects found with ultrasonic frequencies. This significantly reduces or eliminates cavitation erosion and the likelihood of surface damage to the wafer. In general, the higher the frequency, the lower the damage to the wafer.

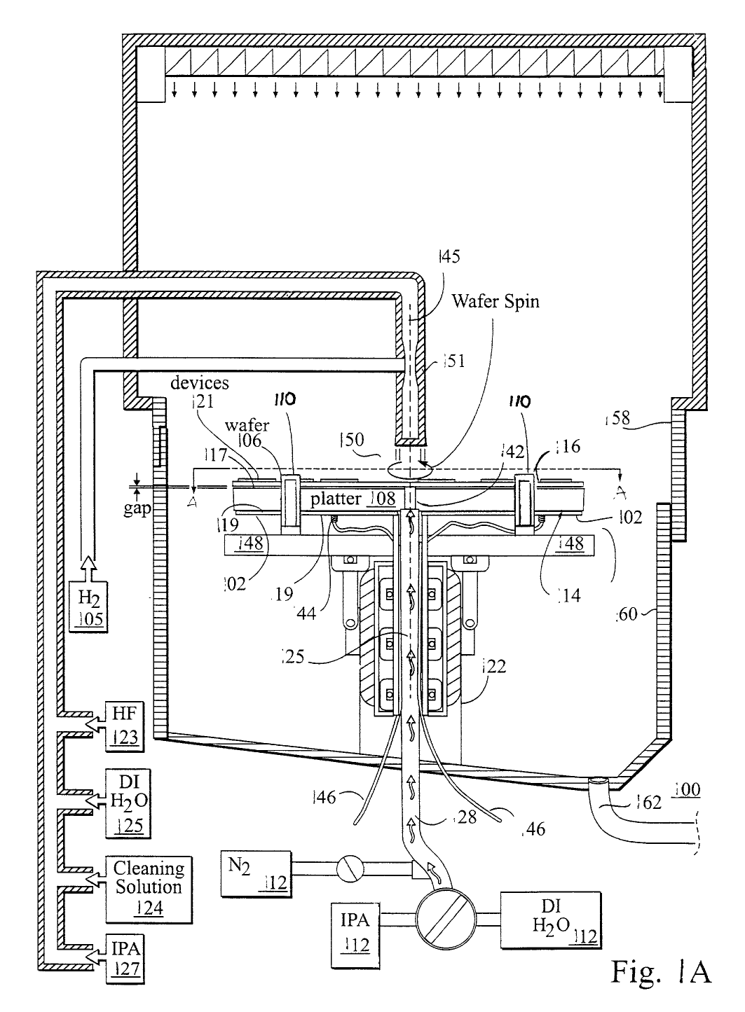

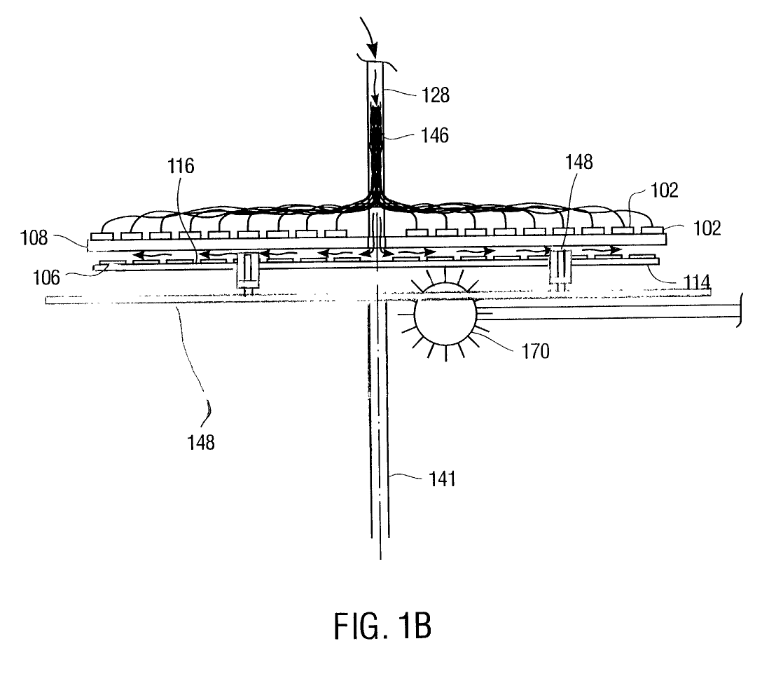

FIG. 1A is an illustration of a single wafer cleaning chamber 100. Positioned within the cleaning chamber 100 is an embodiment of a wafer holding chuck (chuck) 148 for holding a wafer 106. The chuck 148 holds the wafer 106 in a position such that both a wafer top surface 116 and a wafer bottom surface 114 are unobstructed, providing access for chemical cleaning with brushes and/or megasonic energy.

Within the cleaning chamber, one or more acoustic wave transducers (transducers) 102, along with chemicals 112, 123, 124, 125, and 127 can be used to clean, rinse, and dry the individual wafers 106. The one or more transducers 102 can be attached to a platter 108 with the platter 108 horizontally located parallel to and near the wafer 106 during operation of the cleaning chamber 100. The non-transducer side 117 of the platter 108 faces the wafer 106. A first cleaning solution 112 is applied to the non-device side 114 of the wafer 106 while a second cleaning solution 123, 124, 125, and 127 is be applied to the opposite or wafer device side (i.e. semiconductor side) 114. The platter 108 size and the combined area of the transducers 102 are sufficient to provide between 80-100% sonic coverage of the wafer surface 114. The transducers 102 generate megasonic waves that are incident to the wafer surface 114 at an angle approximately normal (perpendicular) to the wafer surface 114. The chuck 148 can be scaled to operate with a wafer 206 that is 200 mm in diameter, 300 mm in diameter, or larger in size.

The megasonic energy is incident to the wafer non-device side 114 with the megasonic energy passing through the wafer body to the wafer device side 116. During the cleaning, rinse and dry cycles, the chuck 148 and the wafer 106 may be rotated (spin) at a selected revolution per minute (rpm) about a wafer central axis 145. Additionally, during any particular cycle, the spin rate may be varied and the megasonic energy varied by pulsing, to optimize the cycle. Therefore, when the invention is being practiced, the wafer 106, positioned in the chuck 148, can be seeing a first cleaning fluid 112 on a bottom side of the wafer, a second cleaning fluid 123, 124, 125, and 127 on the opposite (top) side, while being rotated and radiated with megasonic energy.

In one embodiment, the megasonic energy first strikes the wafer non-device side 114 that could be damaged by the full force of the sonic waves. Since the megasonic energy is more powerful striking this non-device side 114, only DI water may be needed as the first cleaning solution 112. The megasonic energy is then dampened when passing through the wafer body and exits at the wafer device side 116. A thin film of a stronger second cleaning solution 123, 124, 125, and 127 can be placed on the wafer device side 116. The action of this second cleaning solution 123, 124, 125, and 127 on the device structure 121 is reduced due to the dampened megasonic energy, the small volume of chemicals (thin film) 123, 124, 125, and 127 contacting the device structures 121 and the limitations such a thin film places on cavitation forces.

The chuck 148 may be rotated while holding the wafer 106 throughout the cleaning process or alternatively, the chuck 148 may stop rotation and remain still during portions of the cleaning process. The megasonic energy is in a frequency range of 400 kHz -8 Mz but may be higher. Chemicals such as used in the RCA cleaning process can be applied to the wafer device side 116. The RCA cleaning process is commonly used and is well known to those skilled in the art. The RCA chemistry includes an SC-1 clean (NH₄OH+H₂O₂) 124, rinse (de-ionized or DI water followed by isopropyl vapor in nitrogen gas) 124, SC-2 clean (HCl+H₂O₂) 124, rinse (DI water) 124 and a dry cycle (inert gas). The wafer non-device side 114 may have the same cycles of clean, rinse, and dry but might use only DI water in the clean and rinse cycles.

In this manner, 1/10 the volume of cleaning solutions is used as compared to existing wafer megasonic batch processes. In addition, a wafer cleaning rate of 1 wafer/2 minutes can be achieved which is competitive with the batch processes.

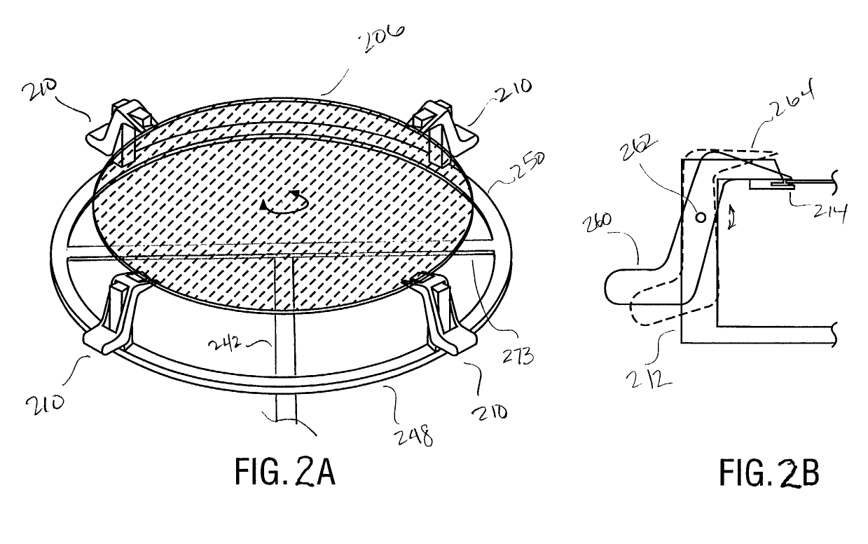

FIG. 1B is an alternate embodiment for using the wafer chuck. In this embodiment, the platter 108 can be inverted from that shown in FIG. 1A. Megasonic energy can be applied to the wafer device side 116 where the chuck 148 provides access to the wafer non-device side 114 surface for cleaning with a brush 170. The brush 170 may approach the wafer 106 from the side as shown in FIG. 1B in a manner that may limit the chuck 148 to rotate 180° or less before changing rotation direction to avoid hitting the brush 170 with a support strut 173 (shown later in FIG. 2A). In another alternate embodiment (not shown), the brush can be fed up through the chuck stem 242 to contact and clean the wafer non-device side surface 114.

FIG. 2A is an illustration of a 3D view of one embodiment of the chuck having moveable clamping arms. FIG. 2B illustrates one embodiment of the moveable clamping arm. Four moveable clamps 210 are positioned to each compress onto the wafer 206 during chuck rotation. The clamps 210 may be made of steel or hastelloy and can be coated (not shown) with a fluoropolymer such as PFA or Halar® (Ausimont USA, Thorofare, N.J.). A fixed portion of each clamp 210, a post 212, can act as a vertical support structure for the moveable clamps 210. Each post 212 can attach to a circular support structure 250 that is attached to a chuck stem 242 with the chuck stem 242 positioned at the chuck 248 axis of rotation 212. Each fixed post 212 can have a lip 214 upon which is positioned the wafer 206.

Each clamping arm has an “S” shaped moveable clamping arm (arm) 260 that pivots about a local axis of rotation 262. The axis of rotation 262 is positioned off-center to the centroid (center-of-mass) of the arm 260. When the chuck 248 is not rotating, the arm 260 rotates about the axis 262 to an open position 264 (dashed line) as a result of gravity. During chuck 248 rotation, centrifugal forces act on the centroid off-set from the arm axis of rotation (off-set) 262 to rotate the arms 260 so as to provide a clamping force onto the wafer 206. Additionally, the faster the chuck 248 rotation rate, the greater the clamping force applied to the wafer 206 by the arms 260. When the chuck 248 is at rest, the wafer 406 can be removed or installed from the open clamps 210.

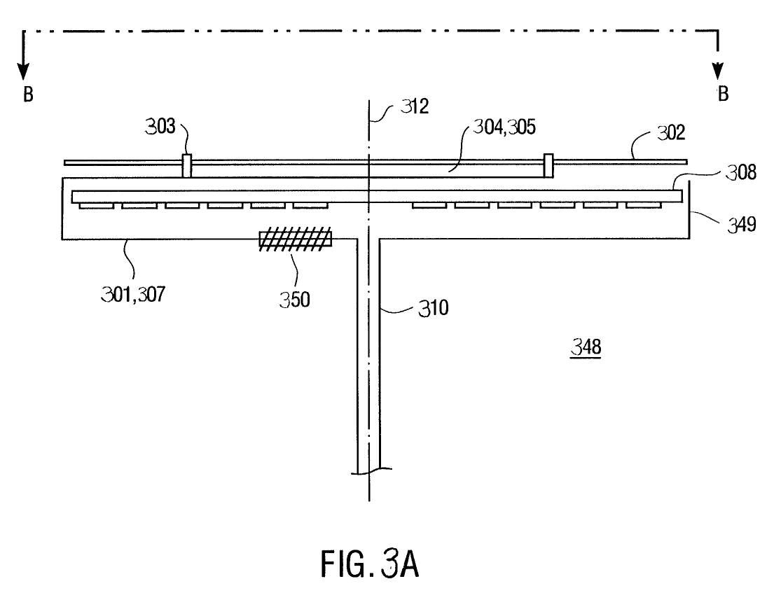

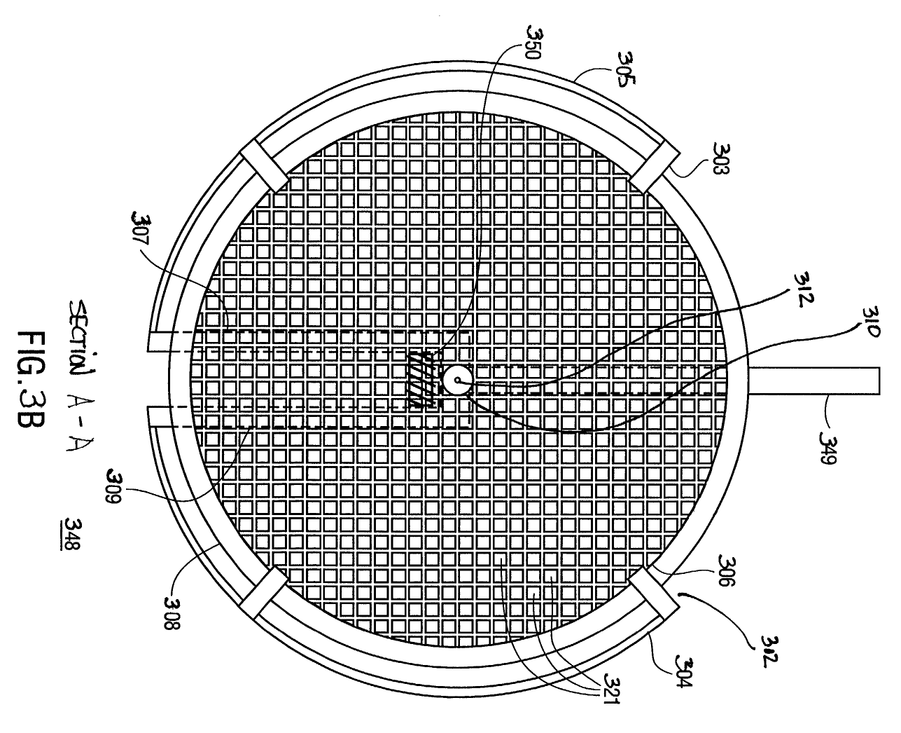

FIG. 3A is a cross-section of an alternate embodiment of the wafer holding chuck. FIG. 3B is a top view of the alternate embodiment of the wafer holding chuck. Two clamping arms 304 and 305 are positioned to clamp onto the wafer 306 with a pair of grips 302 and 303. The chuck 348 can be made of steel or hastelloy and may be coated (not shown) with a fluoropolymer such as PFA or Halar® (Ausimont USA, Thorofare, N.J.). The arms 304 and 305 can attach at ends of two parallel bars 307 and 309 in cantilever fashion, where the opposite ends of the two parallel bars 307 and 309 attach at a support structure 310. The support structure 310 is positioned at an axis of rotation 312 of the chuck 348. A counterbalance 349 can be placed on the opposite side of the support structure 310 to balance the mass of the parallel bars 307 and 309 during rotation of the chuck 348.

FIG. 3B is a top view of the alternate embodiment of the wafer holding chuck. Located between the two parallel bars 307 and 309 is a coil 350 such as a solenoid switch. The coil 350 can be attached to one of the parallel bars 307 or 309 and positioned so that when energized, a magnetic field will be generated. The magnetic field will in turn create an attractive force between the two parallel bars 307 and 309. The parallel bars 307 and 309 are designed with a stiffness such that when the coil 350 is not energized, the arms 304, 305 are in an open position for releasing or receiving a wafer 306. The stiffness of the two parallel bars 307, 309 is such that when the coil 350 is energized, the two parallel bars 307 and 309 are flexible enough to be pulled together, clamping the arms 304 and 305 onto the wafer 306 for wafer processing. Alternatively, the two parallel bars 307 and 309 could be designed to be in a closed position when the coil 350 is not energized. For this case, when the coil 350 is energized, the two parallel bars 307 and 309 could be repelled and the arms 304 and 305 opened.

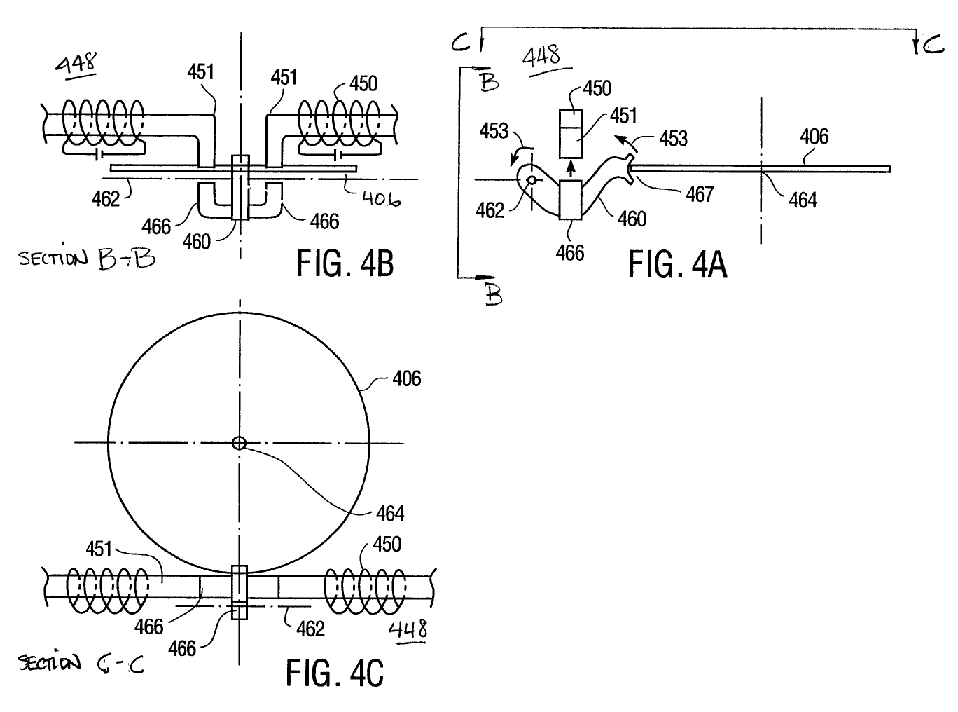

FIG. 4A is an illustration of a cross-section of another alternate embodiment of a wafer holding chuck. FIG. 4B is an illustration of an end view of the embodiment. FIG. 4C is an illustration of a top view of the embodiment. The chuck can have the general shape of the chuck shown in FIG. 2A yet differing in the manner of holding and releasing the wafer 406. In this embodiment, three of more fingers 460 are placed on vertical posts (not shown) where the fingers 460 can each pivot at a local pivot point 462. A magnetic core 466 can be located on each finger 460 such that the centroid (center-of-mass) of the finger is below the pivot point 462. As a result, during rotation of the chuck 448, each finger 460 will rotate about each local pivot point 462 to maintain a grip on the wafer 406 using edges on the finger ends 467. To release the wafer 406, a magnetic attraction is created with the core 466 that pulls the fingers 460 in a direction that rotates the edges 467 away and allows for wafer 406 removal or insertion into the chuck 448. This magnetic attraction with the core 466 is created by a pair of coils 450 and 451 that, when energized, will attract the core 466 and cause rotation 453 of each finger 460 about each finger pivot point 462.

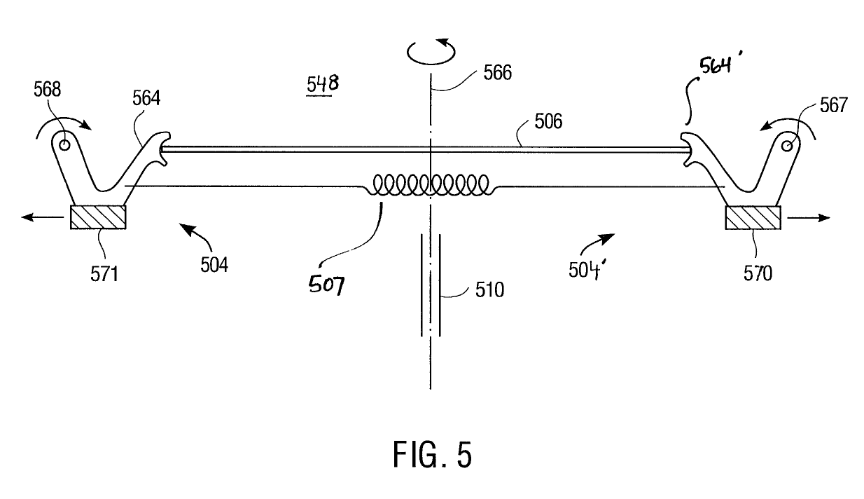

FIG. 5 is an illustration of another alternate embodiment of the wafer holding chuck. FIG. 5 shows a pair of “U” shaped structures (U-structure) 504 and 504′ that are each attached to a pivoting shaft 510, however a second set of U-structures (not shown) could be placed in a plane 90 degrees from the plane shown in FIG. 5. The attachment between the U-structures and the shaft 510 can be accomplished in a manner similar to that shown in FIG. 2A. At one end of each U-structure can be positioned an edge 564 to grip the wafer 506. A spring 507 is placed between the opposing fingers 564 and 564′ such that the fingers 564 and 564′ remain rotated in a position that places the edges 564 and 564′ open for removing or adding the wafer 506. The centroid of the U-structures 564 and 564′ is a distance from the pivot points 567 and 568. Upon rotation of the chuck 548 about the chuck axis of rotation 566, the U-structures 504 and 504′ will respond by overcoming the spring force and rotate about each U-structure axis of rotation 567 and 568. This rotation of the U-structures 504 and 504′ will close the edges 564 and 564′ onto the wafer 506, holding it in a grip during processing. The force of clamping can be increased with additional masses 570 and 571 added to a location on the U-structures 504 and 504′ a distance from the “U” structures axes of rotation 567 and 568.

Returning to FIG. 1, positioned beneath the platter 108 is an electric motor 122 for rotating a chuck 148. A through hole 124 exists in the electric motor center through which is passed the wiring 146 from the platter 108 as well as a line or tube 128 that connects to the feed port 142. Attached to this motor 122, and passing around the platter 108, is the chuck 148, which holds the wafer 106 in a proper location. The chuck 148, along with the motor 122, will rotate the wafer 106 during cleaning operations. During the cleaning cycle, the wafer 106 is rotated (spun) at an rpm of between 10-100 and during the dry and rinse cycles at an rpm of between 3000-6000.

For one embodiment, the chuck 148 positions the wafer 106 centered over and held parallel to the platter 108 at a distance of 3 mm. When in position, the wafer non-device side 114 and device side 116 surfaces are both substantially free of interference from the chuck and access to both surfaces is available. The wafer non-device side 114 is facing the platter 108. Located above the platter 108 and wafer 106, is a spray device or nozzle 151. Through this nozzle 151 passes the RCA cleaning fluids during the process cycles. The nozzle 151 produces flow 150 onto the wafer device side 116 with each of the fluids 104 in the cleaning process. The nozzle design must accomplish two goals, first, the nozzle 151 must apply each fluid 123, 124, 125, and 127 to the spinning wafer 106 at a rate to completely coat the wafer 106 surface and yet minimize the use of chemicals 123, 124, 125, and 127. Secondly, the nozzle 151 must entrain or dissolve enough H₂ gas 105 into the solution so as to optimize cavitation.

A desired continuous fluid film thickness on the wafer is 100 microns. To keep the fluid film at this thickness, the fluid 123, 124, 125, and 127 can be converted at the nozzle 151 into a mist having a particular mean diameter droplet size. All nozzle designs are limited as to how small a droplet size they can create. To meet the requirements of minimal fluid usage, a further reduction in droplet size is required. One method of reducing the droplet size beyond this theoretical limit is to entrain a gas into the fluid. This, as mentioned above, has the further benefit of optimizing cavitation.

After the last rinse cycle is complete there is a dry cycle to dry the wafer 106. The rinse cycle can include the use of isopropyl alcohol (IPA) vapor placed within a nitrogen gas (N₂) steam that injected through the fluid feed port 142 to impact the wafer backside surface 114 as well as the nozzle 151 to impact the wafer topside surface 116. The IPA, having a lower surface tension than water, will wet out the surface better and form a smaller boundary layer. The combination of high wafer rpm, IPA as a wetting agent, and N₂ gas pressure striking the wafer 106 reduces the rinse time for the wafer 106. A dry cycle follows the rinse cycle where an inert gas such as nitrogen is fed through the nozzle 151 to dry the wafer top surface 116 and through the feed port 142 to dry the wafer bottom surface 114.

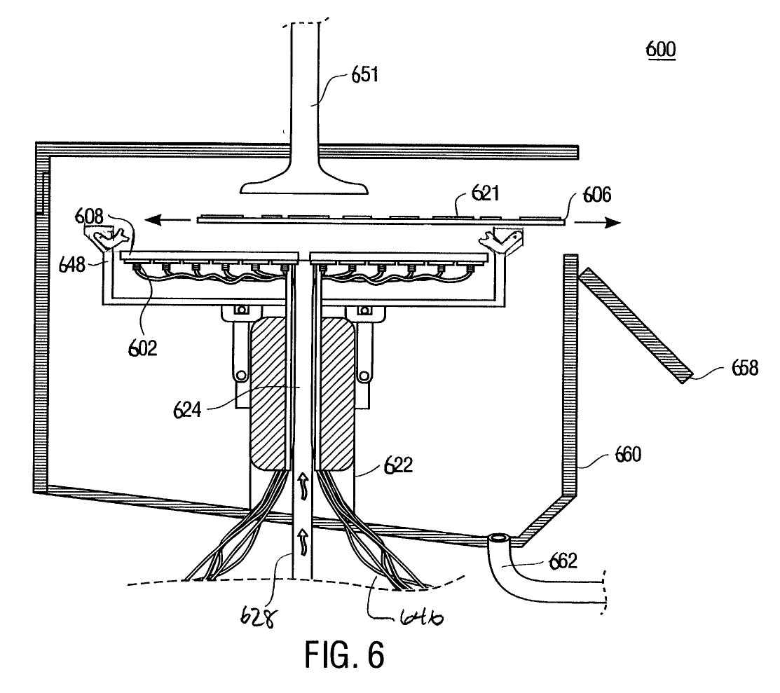

FIG. 6 is an illustration of a removal/insertion operation of the wafer. For wafer 606 removal from the cleaning chamber assembly 600, the chuck 648 is moved toward the nozzle 651 approximately 1″, the chuck 648 releases the wafer 606 for removal by an external robot arm (not shown). An access door 658 moves to provide an opening in the cleaning chamber 660.

In this manner, a wafer 606 can be installed, cleaned, and removed without having the system move much of the cleaning apparatus such as the platter 608, the electric motor 622, the fluid tubing 628 or electrical wiring 646.

We claim:

1. A chuck for holding a wafer, comprising:
a plurality of moveable clamping arms each pivotally attached to;
one or more fixed support structures; and
a center-of-mass of each of the moveable clamping arms positioned a distance from the pivot point of each of the moveable clamping arms, such that when the chuck is at rest, the plurality of moveable clamping arms rotate to release a grip on the wafer, and when the chuck is rotating, the plurality of moveable clamping arms rotate to grip the wafer.

2. The chuck of claim 1, wherein the one or more support structures each has a lip to support the wafer at a wafer bottom surface.

3. The chuck of claim 1, wherein the plurality of moveable clamping arms are capable of rotating to contact the wafer at a wafer top surface.

4. The chuck of claim 1, wherein when the chuck is at rest, a gravity force causes the rotation of the moveable clamping arms to the position for wafer release.

5. The chuck of claim 1, wherein when the chuck is rotating, centrifugal forces cause the rotation of the moveable clamping arms to the position for griping the wafer.

6. A chuck for holding a wafer, comprising:
a plurality of moveable clamping arms each pivotally attached to one or more fixed support structures;
a plurality of coils, attached to the one or more fixed support structures;
a plurality of cores, each attached to one of the plurality of moveable clamping arms; and
a center-of-mass of each of the moveable clamping arms positioned a distance from the pivot point of each of the moveable clamping arms, such that when the chuck is at rest, the plurality of moveable clamping arms are capable of rotating by gravity into a position to release the wafer, and when the plurality of coils are energized, the moveable clamping arms are capable of rotating to grip the wafer.

7. The chuck of claim 6, wherein the plurality of moveable clamping arms each has a curved edge capable of gripping the wafer.

8. A chuck for holding a wafer, comprising:
a plurality of clamping arms, each attached to one or more pairs of support beams, and one or more coils, such that when the one or more coils are energized, each of the one or more pairs of parallel beams move.

9. The chuck of claim 8, wherein the one or more pairs of parallel beams move together to grip the wafer.

10. A chuck of claim 8, wherein the one or more pairs of parallel beams move apart.

11. A chuck for holding a wafer, comprising:
a plurality of moveable clamping arms;
a spring connected to each of the plurality of moveable clamping arms, wherein the spring maintains each of the plurality of moveable clamping arms in a position to release the wafer; and
a center-of-gravity for each of the plurality of moveable clamping arms off-set from a pivot point for each of the plurality of moveable clamping arms such that a rotation of the chuck will rotate each of the plurality of moveable clamping arms into a position that grips the wafer.

12. A method for chucking a wafer; comprising:
rotating each of a plurality of moveable clamping arms with a force to a wafer release position;
installing the wafer;
rotating the chuck;
rotating each of the plurality of moveable clamping arms to a wafer grip position with a centrifugal force as a result of the chuck rotation;
stopping the chuck rotation; and
rotating each of the plurality of moveable clamping arms with the force to the wafer release position.

13. The method of claim 12, wherein the force is gravity.

14. The method of claim 12, wherein the force is created by a spring.

15. The method of claim 12, wherein the force is created by a magnetic coil.
